(19) United States
(12) Patent Application Publication
(10) Pub. No.: US 2017/0032659 A1
(43) Pub. Date: Feb. 2, 2017

(54) WEARABLE MULTI-PROTOCOL SAFETY DEVICE

(71) Applicant: 10FIFTY, LLC, Tucson, AZ (US)

(72) Inventors: Cynthia K. Jordan, Tucson, AZ (US); Anne M. Sarabia, Tucson, AZ (US); Lajoo N. Motwani, Tucson, AZ (US); John F. Rix, Tucson, AZ (US)

(21) Appl. No.: 15/047,270

(22) Filed: Feb. 18, 2016

Related U.S. Application Data
(60) Provisional application No. 62/198,563, filed on Jul. 29, 2015.

(51) Int. Cl. G08B 25/01

(52) U.S. Cl. CPC G08B 25/016

(57) ABSTRACT

A wearable device for personal protection is disclosed. The device comprises a mechanical housing, battery, electronic circuit, microphone, speaker, and communication hardware supporting a variety of network communications. The button is used for initiating a request for assistance. The device is capable of providing the user with a means of personal protection via initiating a request for assistance utilizing variations of network protocols to find a connection to a monitoring service via a plurality of network channels.

### CROSS REFERENCE TO RELATED APPLICATIONS

This application claims priority from U.S. Provisional Application Ser. No. 62/198,563 filed Jul. 29, 2015, the contents of which are incorporated herein by reference.

### BACKGROUND OF THE INVENTION

1. Field of the Invention

The invention relates generally to personal protection systems, and more specifically to personal protection systems comprising wearable electronics.

2. Background of the Invention

Personal protection systems are widely used to protect individuals from harm, be it a breach of personal security or medical situation. Some security systems are remotely monitored. Most personal protection systems are limited in scope to provide the security or monitoring service to a well-defined area, such as for example, a structure or sub-structure and are substantially permanent installations.

Others have attempted to provide personal protection systems to protect or even monitor an individual. Some systems even provide the user with the capability of sending text messages via a connection to their phones; other systems require a dedicated radio for communications within a specified range.

For example, U.S. Patent Application Publication No. 2014/0143801 discloses a system for transmitting a video stream over an emergency media channel to provide evacuation routing information associated with a geographic region responsive to receiving an emergency notification. U.S. Application Publication No. 2012/0208462 discloses a portable terminal and a method for discovering wirelessly connectable devices. U.S. Patent Application Publication No. 2015/0019124 discloses a system and method for locating, tracking, and/or monitoring the status of emergency personnel. U.S. Pat. No. 9,035,776 discloses a system and method for remote monitoring and tracking the use of safety gears capable of enabling immediate response in the event of an accident or emergency.

However, none of the above disclosures a wearable device capable of pinning other mobile devices in proximity until a proximate mobile device is found and until the proximate device starts initialing a help call. Accordingly, a need still exists for a personal protection system that is wearable, portable, and rapidly deployable which still provides the functionality of conventional permanent fixed alert systems that give the user the flexibility of travel, location, and network protocol.

It would be desirable to have a personal protection system comprising wearable electronics for enhanced personal safety functionalities.

### SUMMARY OF THE INVENTION

Embodiments of the invention relate to a wearable electronics for personal protection.

In accordance with one embodiment of the present invention, a wearable personal protection device for individual deployment is disclosed. The device comprises a mechanical housing, battery, electronic circuit, microphone, speaker, and communication hardware supporting a variety of network communications. The device preferably includes a clip for attaching to the user's personal item or clothing. The button is used for initiating a request for assistance or an alert input. The device is capable of providing the user with a means of personal protection via initiating a request for assistance utilizing variations of network protocols or channels to find a connection to a monitoring service via various paths, such as a cellular phone call via a coupled smartphone, a SMS text messaging or VOIP voice communication via an access point, satellite or via a mesh network.

In one embodiment the personal protection device comprises a wearable case.

In another embodiment, the personal protection device comprises a first transceiver, a second transceiver and a third transceiver; and the at least one network channel comprises a first network channel, a second network channel and a third network channel. In such embodiment the first transceiver preferably transmits the alert message via the first network channel, the second transceiver transmits the alert message via the second network channel and the third transceiver transmits the alert message via third network channel. Also, in such embodiment the first network channel preferably is a personal area networks (PAN) channel, the second network channel is a wireless local area network (WLAN) channel and the third network channel is a mesh network channel. In such embodiment the PAN channel preferably is a Bluetooth channel, the WLAN channel is a Wi-Fi channel and the mesh network channel is a ZigBee Communications Protocol channel, and the alert message preferably is transmitted via the Bluetooth channel, the Wi-Fi channel and the ZigBee Communications Protocol channel concurrently or sequentially.

In another embodiment, the protection device hardware, including power source, microphone, speaker, processor, indicator, button, and one or more communication hardware protocols, is contained in a single, portable, weather resistant case. The protection device is worn by a user and capable of pairing to a smartphone, or capable of paring to other devices in proximity utilizing a variety of network protocols if the phone pairing has been unavailable or compromised. This capability of utilizing a variety of network protocols to establish communication with a monitoring service greatly expands the utility, versatility, range and capability of other types of personal protection systems.

The present invention also provides a method of transmitting alert message for personal protection, the method comprising generating an alert message at a wearable personal protection device; coupling the wearable personal protection device to a monitoring service via at least one network channel; and transmitting the alert message from the wearable personal protection device to the monitoring service via the at least one network channel or satellite.

In one embodiment the at least one network channel comprises a first network channel, a second network channel and a third network channel. In such embodiment the first network channel preferably is a personal area networks (PAN) channel, the second network channel is a wireless local area network (WLAN) channel and the third network channel is a mesh network channel. In such embodiment the PAN channel preferably is a Bluetooth channel, the WLAN channel preferably is a Wi-Fi channel and the mesh network channel preferably is a ZigBee Communications Protocol channel, and the alert message preferably is transmitted via the Bluetooth channel, the Wi-Fi channel and the ZigBee Communications Protocol channel concurrently or sequentially.

In yet another embodiment the invention provides a method of transmitting alert messages via multiple network channels, the method comprising coupling a wearable personal protection device to a monitoring service via a plurality of network channels comprising at least a personal area networks (PAN) channel, a wireless local area network (WLAN) channel and a mesh network channel; and transmitting an alert message from the wearable personal protection device to the monitoring service via at least one of the plurality of network channels.

In one embodiment the PAN channel is a Bluetooth channel, the WLAN channel is a Wi-Fi channel and the mesh network channel is a ZigBee Communications Protocol channel. In such embodiment the alert message is transmitted via the Bluetooth channel, the Wi-Fi channel and the ZigBee Communications Protocol channel concurrently or sequentially.

In another embodiment the alert message is transmitted from the wearable personal protection device via the Bluetooth channel first; wherein if the wearable personal protection device does not receive an alert response via the Bluetooth channel within a first time threshold, the alert message is retransmitted from the wearable personal protection device via the Bluetooth channel; and wherein if the wearable personal protection device does not receive the alert response via the Bluetooth channel beyond the first time threshold, the alert message is retransmitted from the wearable personal protection device via the Wi-Fi channel. In such embodiment the alert message may be retransmitted from the wearable personal protection device via the Wi-Fi channel if the wearable personal protection device does not receive an alert response via the Wi-Fi channel within a second time threshold; and wherein if the wearable personal protection device does not receive the alert response via the Wi-Fi channel beyond the second time threshold, the alert message is retransmitted from the wearable personal protection device via the ZigBee Communications Protocol channel. In such embodiment the alert message is retransmitted from the wearable personal protection device via the ZigBee Communications Protocol channel if the wearable personal protection device does not receive an alert response via the ZigBee Communications Protocol channel within a third time threshold; and wherein if the wearable personal protection device does not receive the alert response via the ZigBee Communications Protocol channel beyond the third time threshold, the alert message preferably is retransmitted from the wearable personal protection device via the Bluetooth channel.

### BRIEF DESCRIPTION OF THE DRAWINGS

Reference will be made to exemplary embodiments of the present invention that are illustrated in the accompanying figures. Those figures are intended to be illustrative, rather than limiting. Although the present invention is generally described in the context of those embodiments, it is not intended by so doing to limit the scope of the present invention to the particular features of the embodiments depicted and described.

FIG. 1 is an illustration of a personal protection device component diagram in accordance with an embodiment of the present invention.

FIG. 2 is an illustration of the personal protection device in communication with other device using various protocols with an embodiment of the present invention.

FIG. 3 is an illustration of the protection device coupled to a smartphone via a personal area networks (PAN) channel in accordance with an embodiment of the present invention.

FIG. 4 is an illustration of the protection device coupled to access point via a wireless local area network (WLAN) channel with an embodiment of the present invention.

FIG. 5 is an illustration of the protection device coupled to a mesh network via a mesh network channel in accordance with an embodiment of the present invention.

FIG. 6 is an illustration of exemplary pairing process of the personal protection device in accordance with an embodiment of the present invention.

FIG. 7 is an illustration of another exemplary pairing process of the personal protection device in accordance with an embodiment of the present invention.

Various implementations and embodiments may be practiced in line with the specification. All of these implementations and embodiments are intended to be included within the scope of the invention.

### DETAILED DESCRIPTION OF THE PREFERRED EMBODIMENTS

In the following description, for the purpose of explanation, specific details are set forth in order to provide an understanding of the present invention. The present invention may, however, be practiced without some or all of these details. The embodiments of the present invention described below may be incorporated into a number of different means, components, circuits, devices, and systems. Structures and devices shown in block diagram are illustrative of exemplary embodiments of the present invention. Connections between components within the figures are not intended to be limited to direct connections. Instead, connections between components may be modified, re-formatted via intermediary components. When the specification makes reference to “one embodiment” or to “an embodiment”, it is intended to mean that a particular feature, structure, characteristic, or function described in connection with the embodiment being discussed is included in at least one contemplated embodiment of the present invention. Thus, the appearance of the phrase, “in one embodiment,” in different places in the specification does not constitute a plurality of references to a single embodiment of the present invention.

Various embodiments of the invention are used for a wearable personal protection device for individual deployment. The device comprises a mechanical housing, battery, electronic circuit, microphone, speaker, and communication hardware supporting a variety of network communications. The button is used for initiating a request for assistance. The device is capable of providing the user with a means of personal protection via initiating a request for assistance utilizing variations of network protocols to find a connection to a monitoring service via SMS text messaging or VOIP voice communication.

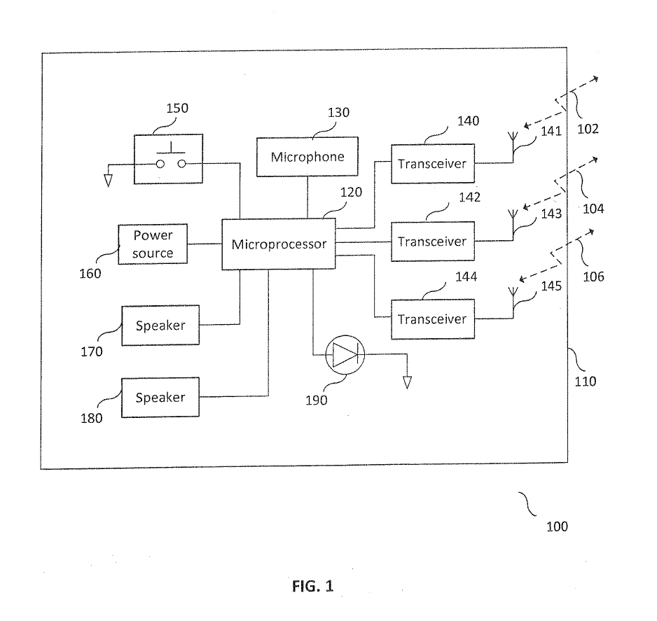

FIG. 1 is an illustration of a personal protection device component diagram in accordance with an embodiment of the present invention. The personal protection device 100 may comprise a memory 130, a first transceiver 140, a first antenna 141 coupled to the first transceiver 140, an alert button 150, a power source 160 and a microprocessor 120 coupled to the aforementioned components. The microprocessor 120 may be a microprocessor, a central processing unit (CPU), a digital signal processing (DSP) circuit, a programmable logic controller (PLC), a microcontroller, or a combination thereof. In certain embodiments, some or all of the functionalities described herein as being performed by the personal protection device 100 may be provided by the microprocessor 120 executing instructions stored on a non-transitory computer-readable medium, such as the memory 130, as shown in FIG. 1.

When the alert button 150 is pressed by a device user, the microprocessor 120 receives an alert input from the alert button 150 and outputs an alert message 121 (or a request for assistance) to the first transceiver 140, which then transmits the alert message 121 via the first antenna 141 using a first network channel.

In some embodiment, the personal protection device 100 may comprise a second transceiver 142, a second antenna 143 coupled to the second transceiver 142. When the microprocessor 120 receives the alert input from the alert button 150 and outputs the alert message 121 to the second transceiver 142, which then transmits the alert message via the second antenna 143 using a second network channel.

In some embodiment, the personal protection device 100 may comprise a third transceiver 144, a third antenna 145 coupled to the third transceiver 144. When the microprocessor 120 receives the alert input from the alert button 150 and outputs the alert message 121 to the third transceiver 144, which then transmits the alert message via the third antenna 145 using a third network channel.

In some embodiments, the first network channel is a personal area networks (PAN) channel, such as a Bluetooth channel. The second network channel is a wireless local area network (WLAN) channel, such as a Wi-Fi channel. The Wi-Fi channel may typically use 2.4 gigahertz (12 cm wavelength) UHF or 5 gigahertz (6 cm wavelength) SI-IF industrial, scientific and medical (ISM) radio bands. The Wi-Fi channel is optionally encrypted with various protocols, such as Wi-Fi Protected Access (WPA) and Wi-Fi Protected Access II (WPA2) protocols. The third channel is a mesh network channel, such as a ZigBee Communications Protocol channel, for the personal protection device 100 to communicate with one or more mesh nodes within a mesh network.

In some embodiments, the alert messages are transmitted from the first transceiver 140, the second transceiver 142 and third transceiver 144 concurrently. In some embodiments, the first antenna 141, the second antenna 143 and the third antenna 145 are actually referred to the same antenna, which couples to the first transceiver 140, the second transceiver 142 and the third transceiver 144. The alert message are transmitted from the first transceiver 140, the second transceiver 142 and third transceiver 144 at different time intervals using the first, the second and the third network channels respectively. The sequence of transmitting the alert message among these three transceivers and transmitting patterns from each of these three transceivers may be controlled by the microprocessor 120 with implementation of a controlling logic pre-stored within the memory 130. The transmitting pattern may include transmitting power and transmit repeating times for the alert message from each transceiver. The transmitting patterns from each of these three transceivers may or may not be the same.

In some embodiments, the alert message may comprise a message pre-stored within the memory 130. In some embodiments, the alert message may comprise a voice message recorded by a microphone 180 coupled to the microprocessor 120. In some embodiments, the alert message may comprise both the pre-stored message and the recorded voice message. The pre-stored message may comprise identification information of the personal protection device 100.

In some embodiments, the personal protection device 100 may further comprise a speaker 170 coupled to the microprocessor 120. The speaker 170 functions to play any audio messages that the personal protection device 100 received from any one of the three network channels.

In some embodiments, the personal protection device 100 may further comprise a LED indicator 190 coupled to the microprocessor 120. The LED indicator 190 functions to indicate the device user which network channel is being used for communication request and whether a communication has been established already. For example, the LED indicator 190 may be a tri-color LED indicator, such as a RGB (red-green-blue) LED diode. When the personal protection device 100 is sending the alert message via the first network channel, the LED indicator 190 outputs a flashing red light. When a communication is established via the first network channel, the LED indicator 190 outputs a steady red light. When the personal protection device 100 is sending the alert message via the second network channel, the LED indicator 190 outputs a flashing green light. When a communication is established via the second network channel, the LED indicator 190 outputs a steady green light. When the personal protection device 100 is sending the alert message via the third network channel, the LED indicator 190 outputs a flashing blue light. When a communication is established via the third network channel, the LED indicator 190 outputs a steady blue light.

In some embodiments, the protection device components, including the aforementioned power source, microphone, speaker, microprocessor, LED indicator, button, and one or more transceivers, antennas, are contained in a single portable case 110. The case 110 may be constructed as a wearable item, such as a waist band, a necklace, a bracelet, etc. In some embodiments, the case 110 is water and/or shock resistant for enhanced robustness such that the personal protection device 100 may be worn, even in a raining weather condition or during sport activities.

Although FIG. 1 is shown with the exemplary component structure for the personal protection device 100, it is understood that various modification may be applied. The modification may be made by including additional components, or by integrating various components into a single component. For example, the first transceiver 140, the second transceiver 142 and third transceiver 144 may be integrated into a single transceiver. The single transceiver may be a MIMO (multiple-input-multiple-output) transceiver and thus being capable of implementing the functions of all three transceivers.

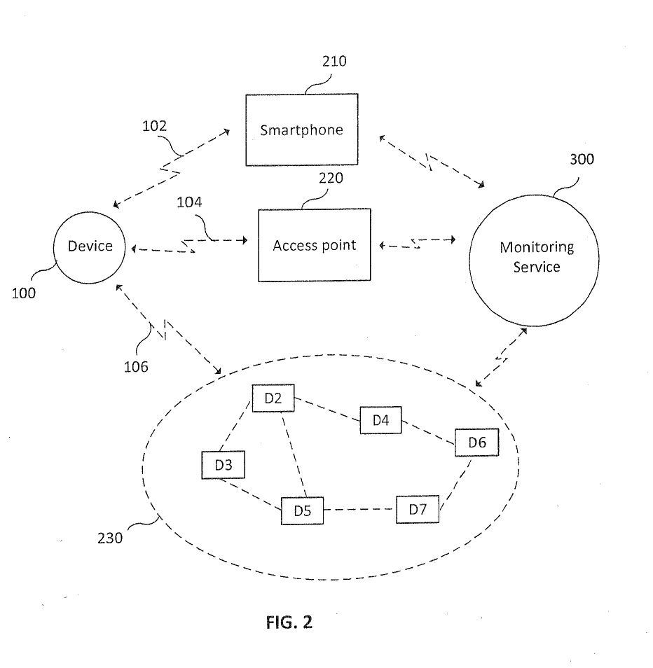

FIG. 2 is an illustration of the personal protection device in communication with other devices using various protocols with an embodiment of the present invention. The personal protection device 100 may couple to a smartphone 210 via the first network channel 102 (such as a Bluetooth channel), to an access point (AP) 220 via the second network channel 104 (such as a Wi-Fi channel), and/or to a mesh network 230 via the third network channel 106 (such as a ZigBee Communications Protocol channel) for alert message dual-way communication. The personal protection device 100 transmits the alert message 121 via at least one of the three network channels. The alert message are transmitted from the first transceiver 140, the second transceiver 142 and third transceiver 144 at different time intervals using the first, the second and the third network channels respectively. The personal protection device 100 may transmit the alert message 121 using all the three network channels concurrently or sequentially using only one network channel at a time with a pre-determined sequence. In some embodiments, the alert message 121 is transmitted using any one of the three network channels with the same transmitting power. In some embodiments, the alert message 121 is transmitted using any one of the three network channels with different transmitting power settings. The transmitting power setting associated with each network channel may be predetermined or dynamically determined by a control logic stored within the memory 130.

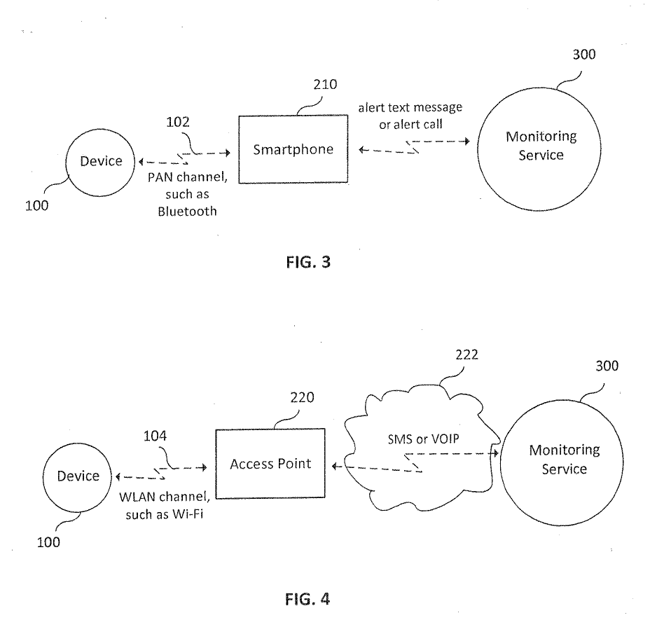

FIG. 3 is an illustration of the protection device coupled to a smartphone via a personal area networks (PAN) channel in accordance with an embodiment of the present invention. The personal protection device 100 couples to a smartphone 210 via the first network channel 102 (such as a Bluetooth channel). The smartphone 210 is a Bluetooth enabled mobile phone. Upon receiving the alert message from the personal protection device 100, the smartphone 210 is configured to send an alert text message or initiate an alert call to a monitoring service 300. Once the alert text message is sent or the alert call is made, the smartphone 210 is configured to send an alert response back to the personal protection device 100. The alert response may comprise audio content to be played by the speaker 170 within the personal protection device 100. In some embodiments, the smartphone 210 is configured to function as a bridge for establishment of a real-time communication path between the protection device 100 and the monitoring service (via the smartphone 210). In certain embodiments, some or all of the functionalities described herein as being performed by the smartphone 210 may be provided by implementing an app installed within the smartphone 210 already.

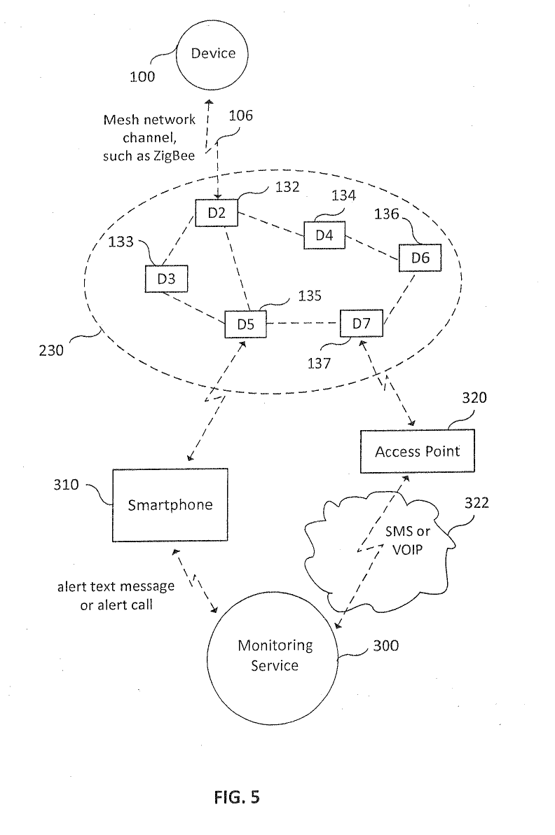

FIG. 4 is an illustration of the protection device coupled to access point via a wireless local area network (WLAN) channel with an embodiment of the present invention. The personal protection device 100 couples to an access point (AP) 220 via the second network channel 104 (such as a Wi-Fi channel). The access point (AP) 220 couples to the monitoring service 300 via a wired or wireless interne connection path 222. Upon receiving the alert message from the personal protection device 100, the AP 220 is configured to send an alert text message or initiate an alert Voice over IP (VoIP) call or an IP telephony call to the monitoring service 300. Once the alert text message is sent or the alert call is made, the AP 220 is configured to send an alert response back to the personal protection device 100. The alert response may comprise audio content to be played by the speaker 170 within the personal protection device 100. In some embodiments, the AP 220 is configured to function as a bridge for establishment of a real-time communication path between the protection device 100 and the monitoring service (via the AP 220). In certain embodiments, some or all of the functionalities described herein as being performed by the AP 220 may be provided by implementing a controlling software or firmware installed within the AP 220.

FIG. 5 is an illustration of the protection device coupled to a mesh network via a mesh network channel in accordance with an embodiment of the present invention. The personal protection device 100 couples to at least one mesh node within the mesh network 230. The mesh network 230 is a network topology in which each mesh node relays data for the network. All mesh nodes cooperate in the distribution of data in the network. Typically, mesh networks can relay messages using either a flooding technique or a routing technique. With routing, the message is propagated along a path by hopping from node to node until it reaches its destination. In some embodiment, to ensure all data paths' availability, the mesh network 230 is configured to allow continuous connections and reconfigure itself around broken paths, using self-healing algorithms such as Shortest Path Bridging. Self-healing allows the mesh network 230 to remain functional even when a node breaks down or when one connection becomes unreliable. As a result, the mesh network 230 is robust, as it is capable of enabling more than one path within the network between the personal protection device 100 and the destination (the monitoring service 300).

Referring to FIG. 5, the personal protection device 100 couples to a mesh node 132 within the mesh network 230 via the third network channel 106 (such as a ZigBee Communications Protocol channel) to transmit an alert message. The alert message is then relayed forward to the monitoring service 300 via at least one forward path. For example, the alert message may be relayed through mesh nodes 132-133-135 and then to a smartphone 310 via Bluetooth coupling between the mesh node 135 and the smartphone 310. The smartphone 310 then sends an alert text message or initiates an alert call to the monitoring service 300. For another example, the alert message may be relayed through mesh nodes 132-134-136-137 and then to an access point 320 via Wi-Fi coupling between the mesh node 137 and the access point 320. The access point 320 then sends an alert text message or initiates an alert VOIP call to the monitoring service 300 via a wired or wireless internet connection path 322.

Once the alert text message is delivered, the monitoring service 300 is configured to send an alert response back to the personal protection device 100 via at least one backward path. In some embodiments, the backward path is the same as the forward path. In certain embodiments, the backward path is the different from the forward path.

Although FIG. 5 is shown with the exemplary mesh network 230 for the alert communication between the personal protection device 100 and the monitoring service 300, it is understood that various modifications may be applied for the mesh network 230. The modifications may include/exclude certain steps and/or adding additional steps, parallel steps, different step sequence arrangements, etc. For example, the mesh network 230 may be a wired mesh network, a wireless mesh network or a hybrid mesh network including both wired node and wireless nodes.

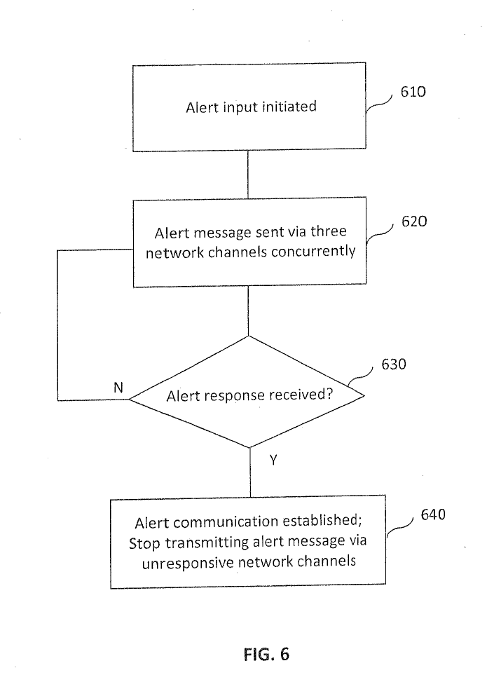

FIG. 6 is an exemplary flow diagram of a personal protection device in accordance with an embodiment of the present invention. At step 610, an alert input is initiated, e.g. by pressing the alert button 150. At step 620, the personal protection device 100 sends out an alert message via all three network channels concurrently. At step 630, the personal protection device 100 verifies whether an alert response is received from the monitoring service 300 via any one of the three network channels. If not, the flow process goes to step 620, wherein the alert message is resent via all three network channels. If the personal protection device 100 receives an alert response via a responding network channel from the three network channels, the flow process goes to step 640, wherein the personal protection device 100 establishes an alert communication with the monitoring service via the responding network channel and stops transmitting alert message via the other two network channels.

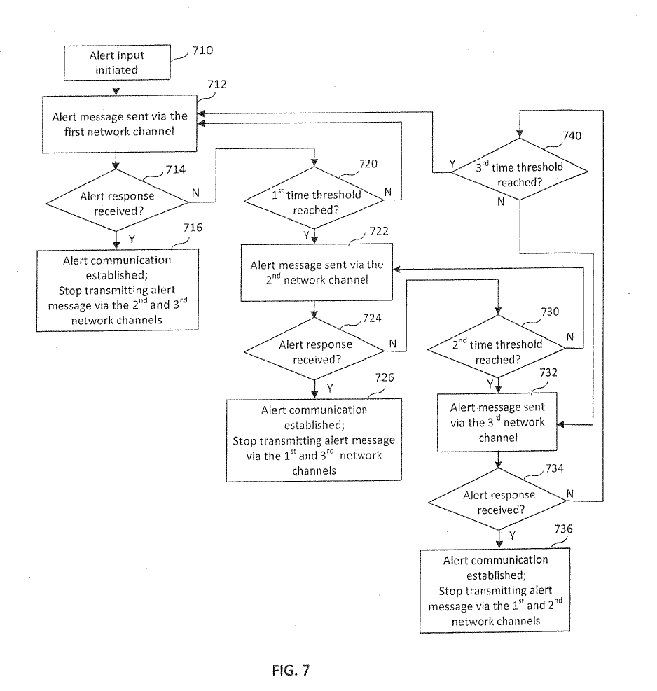

FIG. 7 is an illustration of another exemplary pairing process of the personal protection device in accordance with an embodiment of the present invention. At step 710, an alert input is initiated, e.g. by pressing the alert button 150. At step 712, the personal protection device 100 sends out an alert message via the first network channel.

At step 714, the personal protection device 100 verifies whether an alert response is received from the monitoring service 300 via the first network channel. If an alert response is received, the flow process goes to step 716, wherein the personal protection device 100 establishes an alert communication with the monitoring service via the first network channel. If no alert response received, the flow process goes to step 720, wherein the waiting time for first channel response is compared to a first time threshold to verify whether the waiting time is beyond the first time threshold. If not, the flow process goes back to step 712 for alert message resending via the first network channel. If the waiting time for first channel response is beyond the first time threshold, the flow process goes to step 722, wherein the personal protection device 100 sends out an alert message via the second network channel instead of the first network channel.

At step 724, the personal protection device 100 verifies whether an alert response is received from the monitoring service 300 via the second network channel. If an alert response is received, the flow process goes to step 726, wherein the personal protection device 100 establishes an alert communication with the monitoring service via the second network channel. If an alert response is not received, the flow process goes to step 730, wherein the waiting time for second channel response is compared to a second time threshold to verify whether the waiting time is beyond the second time threshold. If no, the flow process goes back to step 722 for alert message resending via the second network channel. If the waiting time for first channel response is beyond the second time threshold, the flow process goes to step 732, wherein the personal protection device 100 sends out an alert message via the third network channel instead of the second network channel.

At step 734, the personal protection device 100 verifies whether an alert response is received from the monitoring service 300 via the third network channel. If yes, the flow process goes to step 736, wherein the personal protection device 100 establishes an alert communication with the monitoring service via the third network channel. If not, the flow process goes to step 740, wherein the waiting time for the third channel response is compared to a third time threshold to verify whether the waiting time is beyond the third time threshold. If not, the flow process goes back to step 732 for alert message resending via the third network channel. If the waiting time for the third channel response is beyond the third time threshold, the flow process goes to step 712, wherein the personal protection device 100 sends out an alert message via the first network channel again.

In some embodiments, the first, second and third time thresholds are the same. In some embodiments, the first, second and third time thresholds are different from each other. Each time threshold may be pre-determined by a control logic stored within the memory 130, or determined dynamically according to various parameters, such as network channel conditions (e.g. channel SNR, channel latency, etc.), battery power reserve, etc.

Although FIGS. 6 and 7 are shown with the exemplary flow diagram for the alert communication between the personal protection device 100 and the monitoring service 300, it is understood that various modification may be applied for the flow diagrams. The modification may include excluding certain steps and/or adding additional steps, parallel steps, different step sequence arrangements, etc. For example, the personal protection device 100 may send the alert message via the second network channel or the third network channel before the first network channel. For another example, the first, second and third time thresholds may be replaced by a first, a second and a third re-sending count thresholds respectively. The flow process shown in FIG. 7 may be reconstructed accordingly.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A personal protection device using network channels to send an alert message, the personal protection device comprising:
an alert button for an alert input initiation;
a microprocessor coupled to the alert button, the microprocessor receiving the alert input and generating an alert message; and
at least one transceiver coupled to the microprocessor for transmitting the alert message via at least one network channel.

2. The personal protection device of claim 1 wherein the personal protection device further comprises a wearable case optionally including a clip.

3. The personal protection device of claim 1 wherein the at least one transceiver comprises a first transceiver, a second transceiver and a third transceiver; and
wherein at least one network channel comprises a first network channel, a second network channel and a third network channel.

4. The personal protection device of claim 3 wherein the first transceiver transmits the alert message via the first network channel, the second transceiver transmits the alert message via the second network channel and the third transceiver transmits the alert message via third network channel.

5. The personal protection device of claim 4 wherein the first network channel is a personal area networks (PAN) channel, the second network channel is a wireless local area network (WLAN) channel and the third network channel is a mesh network channel.

6. The personal protection device of claim 4 wherein the PAN channel is a Bluetooth channel, the WLAN channel is a Wi-Fi channel and the mesh network channel is a ZigBee Communications Protocol channel.

7. The personal protection device of claim 6 wherein the alert message is transmitted via the Bluetooth channel, the Wi-Fi channel and the ZigBee Communications Protocol channel concurrently or sequentially.

8. The personal protection device of claim 6, further including a microphone and speaker.

9. A method of transmitting alert message for personal protection, the method comprising:
generating an alert message at a wearable personal protection device;
coupling the wearable personal protection device to a monitoring service via at least one network channel; and
transmitting the alert message from the wearable personal protection device to the monitoring service via the at least one network channel or satellite.

10. The method of claim 9 wherein the at least one network channel comprises a first network channel, a second network channel and a third network channel.

11. The method of claim 10 wherein the first network channel is a personal area networks (PAN) channel, the second network channel is a wireless local area network (WLAN) channel and the third network channel is a mesh network channel.

12. The method of claim 11 wherein the PAN channel is a Bluetooth channel, the WLAN channel is a Wi-Fi channel and the mesh network channel is a ZigBee Communications Protocol channel.

13. The method of claim 12 wherein the alert message is transmitted via the Bluetooth channel, the Wi-Fi channel and the ZigBee Communications Protocol channel concurrently or sequentially.

14. The method of claim 9, wherein said alert message is generated by the wearer's voice.

15. A method of transmitting alert messages via multiple network channels, the method comprising:
coupling a wearable personal protection device to a monitoring service via a plurality of network channels comprising at least a personal area networks (PAN) channel, a wireless local area network (WLAN) channel and a mesh network channel; and
transmitting an alert message from the wearable personal protection device to the monitoring service via at least one of the plurality of network channels or satellite.

16. The method of claim 15 wherein the PAN channel is a Bluetooth channel, the WLAN channel is a Wi-Fi channel and the mesh network channel is a ZigBee Communications Protocol channel.

17. The method of claim 16 wherein the alert message is transmitted via the Bluetooth channel, the Wi-Fi channel and the ZigBee Communications Protocol channel concurrently or sequentially.

18. The method of claim 16 wherein the alert message is transmitted from the wearable personal protection device via the Bluetooth channel first;
wherein if the wearable personal protection device does not receive an alert response via the Bluetooth channel within a first time threshold, the alert message is retransmitted from the wearable personal protection device via the Bluetooth channel; and
wherein if the wearable personal protection device does not receive the alert response via the Bluetooth channel beyond the first time threshold, the alert message is retransmitted from the wearable personal protection device via the Wi-Fi channel.

19. The method of claim 18 wherein the alert message is retransmitted from the wearable personal protection device via the Wi-Fi channel if the wearable personal protection device does not receive an alert response via the Wi-Fi channel within a second time threshold; and
wherein if the wearable personal protection device does not receive the alert response via the Wi-Fi channel beyond the second time threshold, the alert message is retransmitted from the wearable personal protection device via the ZigBee Communications Protocol channel.

20. The method of claim 19 wherein the alert message is retransmitted from the wearable personal protection device via the ZigBee Communications Protocol channel if the wearable personal protection device does not receive an alert response via the ZigBee Communications Protocol channel within a third time threshold; and
wherein if the wearable personal protection device does not receive the alert response via the ZigBee Communications Protocol channel beyond the third time threshold, the alert message is retransmitted from the wearable personal protection device via the Bluetooth channel.

21. The method of claim 15, wherein the alert message transmitted is a sound of the wearer's voice.
